(19) United States
(12) Patent Application Publication
(10) Pub. No.: US 2016/0076281 A1
(43) Pub. Date: Mar. 17, 2016

(54) LOCKING DEVICE

(71) Applicant: Craig Dennis CHAPPELL, Semmes, AL (US)

(72) Inventor: Craig Dennis CHAPPELL, Semmes, AL (US)

(21) Appl. No.: 14/853,043

(22) Filed: Sep. 14, 2015

Related U.S. Application Data
(60) Provisional application No. 62/049,714, filed on Sep. 12, 2014.

(51) Int. Cl. E05C 1/00; E05B 65/06; E05B 15/10; E05B 61/00; E05C 19/00; E05C 19/10

(52) U.S. Cl. CPC E05C 1/004; E05C 19/003; E05C 19/10; E05B 15/104; E05B 61/00; E05B 65/06

(57) ABSTRACT

A locking device for securing a gate so as to prevent tampering to the locking engagement of said locking device is provided. The locking device may include a lock latch which slides into a housing for forming the locking engagement therein. The cavity formed by the housing is accessible through a sliding door that encases the cavity and so prevents tampering to the locking engagement. The slide door forms a blade notch that a lock blade may engage, wherein the lock blade is key-actuated through the bottom wall of the housing.

### CROSS-REFERENCE TO RELATED APPLICATION

This application claims the benefit of priority of U.S. provisional application number 62/049,714, filed 12 Sep. 2014, the contents of which are herein incorporated by reference.

### BACKGROUND OF THE INVENTION

The present invention relates to locking systems and, more particularly, to a locking device for securing a gate so as to prevent tampering to the locking engagement of said locking device.

Current security gates include locks that are at risk of being cut off by bolt-cutters or shot off, especially in rural and remote areas, resulting in theft or trespassing. This is partially a result of current security gates not being specifically designed for farm gates or other similarly large gate types, but rather being designed for smaller applications, thereby exposing the locking mechanism to tampering.

As can be seen, there is a need for a locking device for securing a gate so as to prevent tampering to the locking engagement of said locking device.

### SUMMARY OF THE INVENTION

In one aspect of the present invention, a locking device includes a lock latch having a housing portion; a lock housing forming a cavity; the cavity defined by two opposing side walls, a top wall, and a bottom wall; two aligned lock holes, each latch hole dimensioned to slidably receiving the housing portion, and each latch hole formed in one of the two opposing side walls; a lock plate disposed in the cavity; an elongated slot formed by the bottom wall; a sliding door dimensioned to slide through the elongated slot so as to substantially extend between the two opposing side walls, the top wall and the bottom walls; and a cam lock disposed within the cavity, wherein the cam lock is adapted to securely engage the sliding door.

In another aspect of the present invention, the locking device includes a J-shaped lock latch having a housing portion, wherein the housing portion forms a plurality of housing holes; a lock housing forming a cavity; the cavity defined by two opposing side walls, a top wall, and a bottom wall; two aligned lock holes, each latch hole dimensioned to slidably receiving the housing portion, and each latch hole formed in one of the two opposing side walls; a lock plate disposed in the cavity, wherein the lock plate forms at least one plate hole; a latch fastener; an elongated slot formed by the bottom wall; a sliding door dimensioned to slide through the elongated slot so as to substantially extend between the two opposing side walls, the top wall and the bottom walls; a plurality of door guides disposed along the two opposing side walls, wherein the plurality of door guides are adapted to slidably receive the securely engaged sliding door; an arcuate blade notch formed in the sliding door; and a cam lock disposed within the cavity, wherein the cam lock has a lock blade rotably connected thereto, wherein the lock blade has a distal end having an arcuate shape adapted to securely engage the blade notch, whereby a locking engagement is formed by the latch fastener engaging the at least one plate hole and at least one of the plurality of housing holes that align thereto.

These and other features, aspects and advantages of the present invention will become better understood with reference to the following drawings, description and claims.

### BRIEF DESCRIPTION OF THE DRAWINGS

FIG. 1 is a front elevation view of an exemplary embodiment of the present invention;

FIG. 2 is a front top view of an exemplary embodiment of the present invention;

FIG. 3 is a front bottom perspective view of an exemplary embodiment of the present invention;

FIG. 4 is a front top perspective view of an exemplary embodiment of the present invention, with housing walls broken away for showing inter-housing components so as to demonstrate a locked engagement;

FIG. 5 is a front top perspective view of an exemplary embodiment of the present invention, with housing walls broken away for showing inter-housing components and demonstrating an opened configuration;

FIG. 6 is an exploded perspective view of an exemplary embodiment of the present invention; and

FIG. 7 is a cross-sectional view of an exemplary embodiment of the present invention; taken along line 7-7 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a locking device for securing a gate so as to prevent tampering to the locking engagement of said locking device. The locking device may include a lock latch which slides into a housing for forming the locking engagement therein. The cavity formed by the housing is accessible through a sliding door that encases the cavity and so prevents tampering to the locking engagement. The slide door forms a blade notch that a lock blade may engage, wherein the lock blade is key-actuated through the bottom wall of the housing.

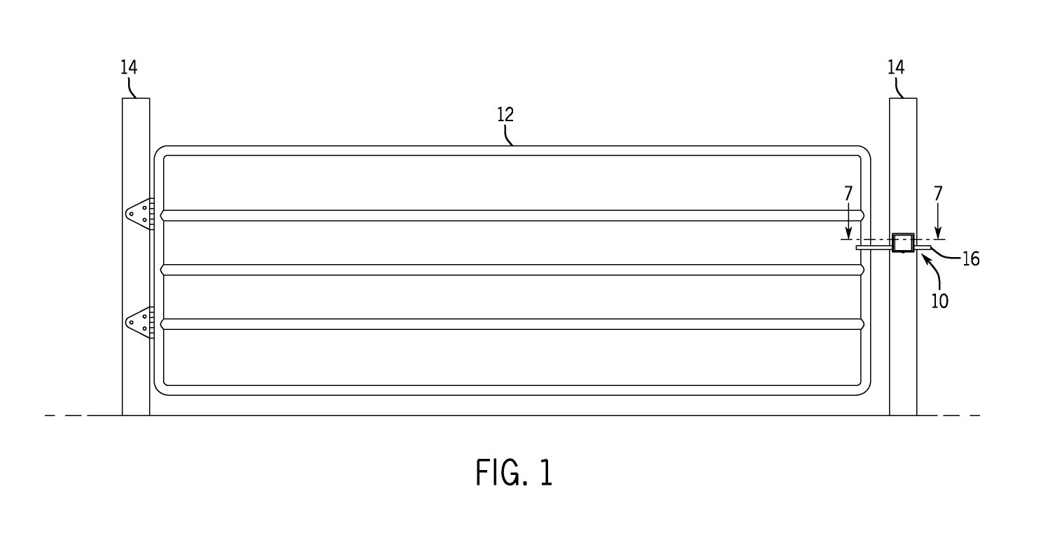

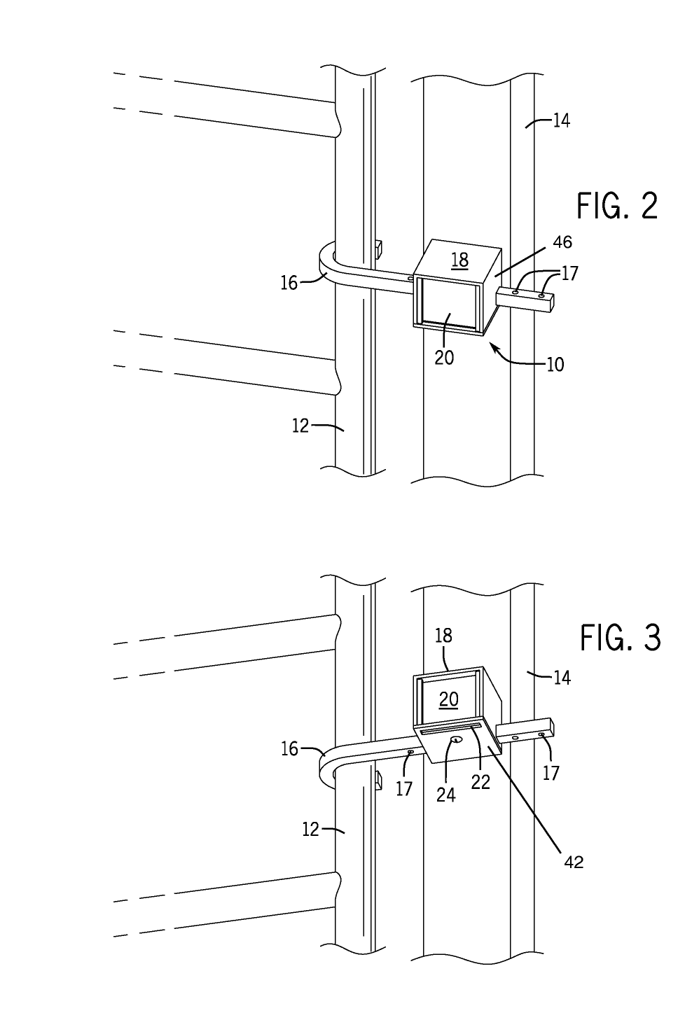

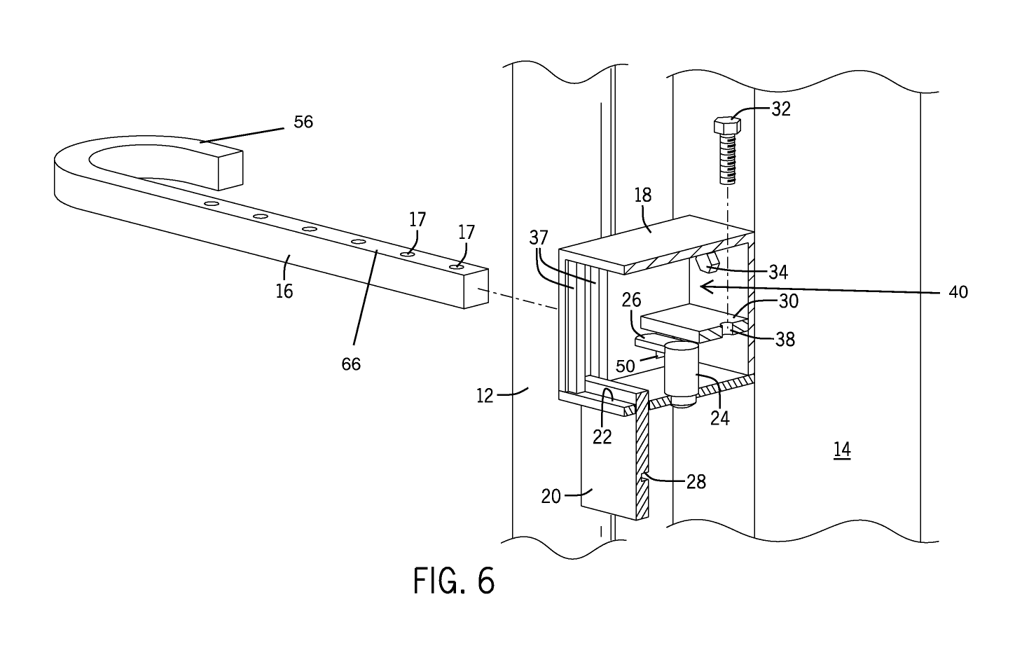

Referring to FIGS. 1 through 7, the present invention may include locking device 10 for locking a gate so as to be tamper-proof. The locking device 10 may be made of material that is sturdy and not easily deformed, like steel. The locking device 10 may include a lock latch 16 and a lock housing 18. The lock latch 16 may include a hook portion 66 and a housed portion 56. The hook portion 66 may be dimensioned and adapted for hooking around a first portion 12 of the gate, in an engaged position, as illustrated in FIGS. 1-3. In certain embodiment, the lock latch 16 may be J-shaped. The lock latch 16, or portions thereof, may be cylindrical in shape. A plurality of housing holes 17 may be formed along the housing portion 56, in a spaced-apart manner.

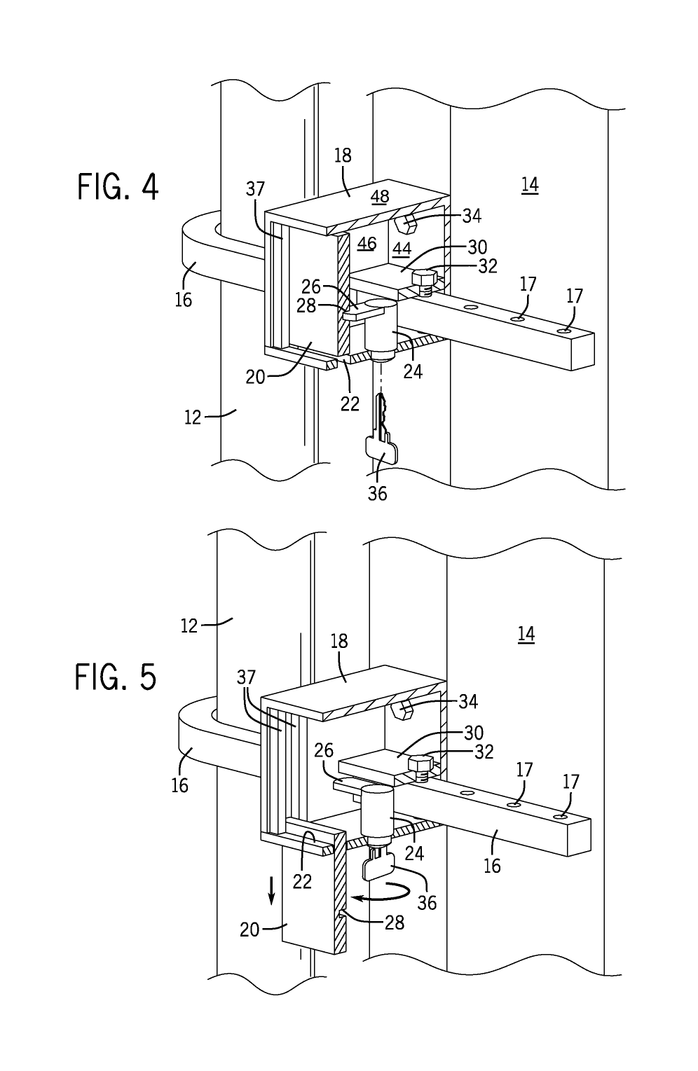

The lock housing 18 may form a cavity 40 defined by opposing side walls 46, a back wall 44, a bottom wall 42 and a top wall 48. The back wall 44 may form a plurality of fastener holes so that a plurality of fasteners 34 may rigidly attach the lock housing 18 to a second portion 14 of the gate, like a post or nearby structural element, as illustrated in FIGS. 4 and 5

The opposing side walls 46 may form aligned latch holes 50, each latch hole 50 dimensioned to slidably receive the lock latch 16, whereby the housing portion 56 is disposed in the cavity 40, in the engaged position.

A lock plate 30 may be perpendicularly joined to at least one side wall 46, along a periphery of at least one latch hole 50 so as to extend through the cavity 40, adjacent to the housing portion 56. The lock plate 30 may form at least one plate hole 38, each plate hole 38 is dimensioned to receive a latch fastener 32 that also can be removably secured in an aligned housing hole 17, forming a locking engagement, as illustrated in FIGS. 4-6. When the latch fastener 32 is not secured to a housing hole 17, the locking device 10 is positioned in an unlocked engagement.

An elongated slot 22 may be formed in the bottom wall 42, wherein the elongated slot 22 may de dimensioned and adapted to slidably receive a sliding door 20 dimensioned to substantially extend from the top wall 48 to the bottom wall 42, while substantially extending between the opposing side walls 46 so as to encase the cavity 40, in an encased configuration, as illustrated in FIG. 4. A blade notch 28 may be formed near a top portion of the sliding door 20, so as to face the cavity 40. A plurality of door guides 37 may be joined to the opposing side walls 46 so as the slidably receive the sliding door 20 in the encased configuration.

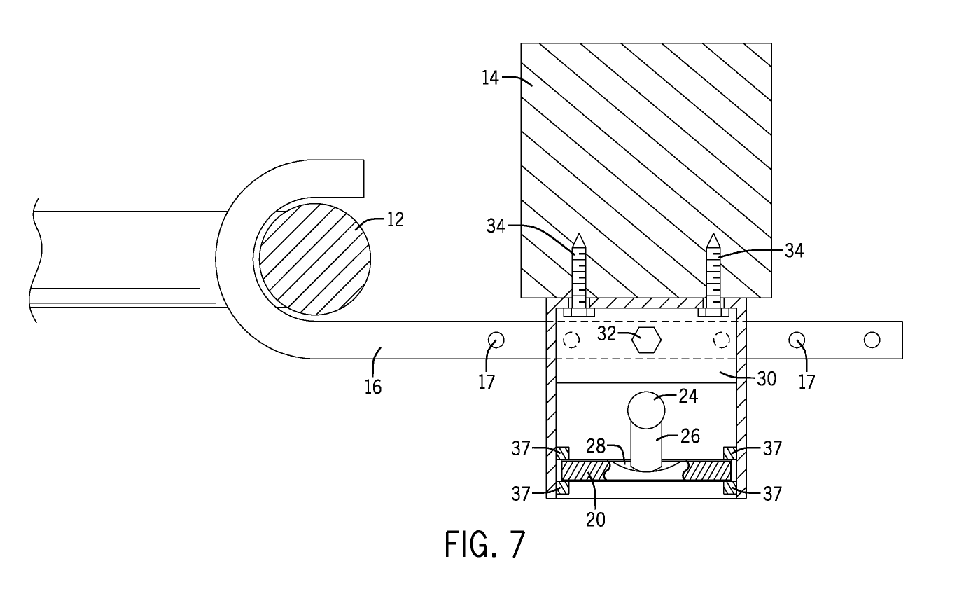

A cam lock 24 may be perpendicularly joined to the bottom wall 44 so that its key hole 25 is outward facing, while its cylinder is inward facing within the cavity 40, as illustrated in FIGS. 4 and 5. A lock blade 26 may be rotably connected to the cylinder of the cam lock 24. The distal end 27 of the lock blade 26 may form a curved and/or arcuate shape. The cam lock 24 may be adapted so as to be actuated by a key 36, whereby the rotation of the key 36 causes the lock blade 26 to rotate within the cavity 40. The cam lock 24 may be disposed along the bottom wall 44 so that the distal end 27 of the lock blade 26 snugly slides through the void formed by the blade notch 28 in the engaged configuration, defining a securely engaged configuration. In certain embodiments, the blade notch 28 may be arcuate shapes and dimensioned to receive the distal end 27, as illustrated in FIG. 7. When a portion of the lock blade 26 does not occupy the blade notch 28, the sliding door 20 gravitates through the elongated slot 22, defining an opened configuration.

A method of using the present invention may include the following. The locking device 10 disclosed above may be provided. An operator first may rigidly attach the lock housing 18 to the second portion 14 of the gate to be secured by the locking device 10. In the opened configuration, and before hooking the hook portion 66 about the second portion 12 of the gate, the operator may slide the housing portion 56 through the at least one latch hole 50 so as to removably secure a latch fastener 32 through a plate hole 38 and the aligned housing hole 17, defining the locking engagement. Then the operator may slide the sliding door 20 through the elongated slot 22 and the door guides 37, into the encased configuration. Then by rotation of the key 36 in the key hole 25, the operator may cause the lock blade 26 to engage the blade notch 28 in the securely engaged configuration for preventing tampering with the locked engagement of the lock bar 16 and the lock housing 18.

When the gate needs to be unsecured by the lock bar 16, the operator simply rotates the key 36 to withdraw the lock blade 26 from the blade notch 28, whereby the sliding door 20 slides through the elongated slot 20 by the force of gravity, enabling the opened configuration for removing the latch fastener 32 and thus the locked engagement.

It should be understood, of course, that the foregoing relates to exemplary embodiments of the invention and that modifications may be made without departing from the spirit and scope of the invention as set forth in the following claims.

What is claimed is:

1. A locking device, comprising:
a lock latch having a housing portion;
a lock housing forming a cavity;
the cavity defined by two opposing side walls, a top wall, and a bottom wall;
two aligned lock holes, each latch hole dimensioned to slidably receiving the housing portion, and each latch hole formed in one of the two opposing side walls;
a lock plate disposed in the cavity;
an elongated slot formed by the bottom wall;
a sliding door dimensioned to slide through the elongated slot so as to substantially extend between the two opposing side walls, the top wall and the bottom walls; and
a cam lock disposed within the cavity, wherein the cam lock is adapted to securely engage the sliding door.

2. The locking device of claim 1, wherein the lock latch further includes a hook portion.

3. The locking device of claim 2, wherein the lock latch forms a J-shape.

4. The locking device of claim 1, wherein the housing portion forms a plurality of housing holes.

5. The locking device of claim 4, wherein the lock plate forms at least one plate hole.

6. The locking device of claim 5, further comprising a latch fastener, wherein a locking engagement is formed by the latch fastener engaging the at least one plate hole and at least one of the plurality of housing holes that align thereto.

7. The locking device of claim 1, further comprising a lock blade rotably connected to the cam lock, wherein the lock blade is adapted for securely engage the sliding door.

8. The locking device of claim 7, further comprising a blade notch formed in the sliding door, wherein the blade notch is adapted to engage a distal portion of the lock blade.

9. The locking device of claim 8, wherein the distal portion of the lock blade and the blade notch are both arcuate.

10. The locking device of claim 1, further comprising a plurality of door guides disposed along the two opposing side walls, wherein the plurality of door guides are adapted to slidably receive the securely engaged sliding door.

11. A locking device, comprising:
a J-shaped lock latch having a housing portion, wherein the housing portion forms a plurality of housing holes;
a lock housing forming a cavity;
the cavity defined by two opposing side walls, a top wall, and a bottom wall;
two aligned lock holes, each latch hole dimensioned to slidably receiving the housing portion, and each latch hole formed in one of the two opposing side walls;
a lock plate disposed in the cavity, wherein the lock plate forms at least one plate hole;
a latch fastener;
an elongated slot formed by the bottom wall;
a sliding door dimensioned to slide through the elongated slot so as to substantially extend between the two opposing side walls, the top wall and the bottom walls;
a plurality of door guides disposed along the two opposing side walls, wherein the plurality of door guides are adapted to slidably receive the securely engaged sliding door;
an arcuate blade notch formed in the sliding door; and
a cam lock disposed within the cavity, wherein the cam lock has a lock blade rotably connected thereto, wherein the lock blade has a distal end having an arcuate shape adapted to securely engage the blade notch,
whereby a locking engagement is formed by the latch fastener engaging the at least one plate hole and at least one of the plurality of housing holes that align thereto.
